(19) United States
(12) Patent Application Publication
(10) Pub. No.: US 2002/0088179 A1
(43) Pub. Date: Jul. 11, 2002

(54) Autothermal fuel gas reformer assemblage

(76) Inventors: Roger R. Lesieur, Enfield, CT (US); Donald F. Szydlowski, Ellington, CT (US); Thomas J. Barber, West Hartford, CT (US); Louis M. Chiappetta, South Windsor, CT (US); William O. Peschke, Manchester, CT (US)

Correspondence Address: William W. Jones, Patent Counsel, 6 Juniper Lane, Madison, CT, 06443, US

(21) Appl. No.: 10/091,223

(22) Filed: Mar. 5, 2002

Related U.S. Application Data
(62) Division of application No. 09/490,679, filed on Jan. 24, 2000.

(51) Int. Cl. C01B 3/32; B01J 8/02

(52) U.S. Cl. 48/198.7; 48/197 FM; 48/127.9; 422/195; 422/211; 422/190

(57) ABSTRACT

A tubular fuel gas-steam reformer assembly, preferably an autothermal reformer assembly, for use in a fuel cell power plant, includes a fuel-steam vaporizer, a fuel-steam and air mixing station, and a catalyst bed. The catalyst bed can include catalyzed alumina pellets, or a monolith such as a foam or honeycomb body which is preferably formed from a high temperature material such as a steel alloy, or from a ceramic material. The fuel-steam mixture is vaporized in the vaporizer and then passes into the mixing station. The mixing station comprises a plurality of mixing tubes which open into the catalyst bed. The mixing tubes extend through a manifold and include openings which interconnect the interior of the tubes with the manifold. The openings have axes which are perpendicular to the axis of each of the mixing tubes, and are positioned on the tubes at locations which are dictated by the diameter of the mixing tubes and which will ensure thorough mixing of the air and fuel-steam streams. A preferred mode of operation involves introducing the fuel-steam stream into the mixing tubes from the vaporizer and feeding the air into the manifold. The Δp between the air supply and the fuel-steam stream is relatively small.

### DESCRIPTION

1. Technical Field

This invention relates to a fuel gas steam reformer assemblage for reforming light hydrocarbon fuels such as methanol, ethanol, gasoline, diesel fuel and the like, and converting them to a hydrogen-rich fuel stream suitable for use in a fuel cell power plant. More particularly, this invention relates to an autothermal fuel gas steam reformer assemblage which employs a pre-catalyst bed mixing apparatus that provides an essentially uniform fuel/steam/air mixture, wherein at least 90% of the fuel, steam, and air are thoroughly admixed, for introduction into the catalyst bed in the reformer. The steam reformer assemblage of this invention is suitable for use in mobile applications.

2. Background Art

Fuel cell power plants include fuel gas steam reformers which are operable to catalytically convert a fuel gas, such as natural gas or heavier hydrocarbons, into the primary constituents of hydrogen and carbon dioxide. The conversion involves passing a mixture of the fuel gas and, in certain applications, steam through a catalytic bed which is heated to a reforming temperature that varies, depending upon the fuel being reformed. A catalyst typically used is a nickel catalyst which is deposited on alumina pellets. Of the three types of reformers most commonly used for providing a hydrogen-rich gas stream to fuel cell power plants, tubular thermal steam reformers, autothermal reformers, and catalyzed wall reformers, the autothermal reformer has a need for rapid mixing capabilities in order to thoroughly mix the fuel-steam and air prior to entrance into the reformer catalyst bed.

U.S. Pat. No. 4,451,578, granted May 29, 1984 contains a discussion of autothermal reforming assemblages, and is incorporated herein in its entirety. The autothermal reformer assembly described in the '578 patent utilizes catalyzed alumina pellets. In the design of auto-thermal reformers for hydrogen-fueled fuel cell systems, there is a need for rapid and thorough mixing of the reactants (air, steam and fuel) prior to entry of the reactants into the catalyst bed. The autothermal reformers require a mixture of steam, fuel and air in order to operate properly. These reformers are desirable for use in mobile applications, such as in vehicles which are powered by electricity generated by a fuel cell power plant. The reason for this is that autothermal reformers can be compact, simple in design, and are better suited for operation with a fuel such as gasoline. One requirement for a fuel processing system that is suitable for use in mobile applications is that the system should be as compact as possible, thus, the mixing of the steam, fuel and air constituents should be accomplished in as as compact an envelope as possible. Once the constituents are mixed, the residence time in the mixer must be limited to prevent carbon deposition. The problem encountered with such a compact assemblage is how to achieve the thorough degree of mixing needed in the autothermal reformer in as short a time and distance as possible with oxygen to carbon ratios as low as 0.30 to 0.35.

### DESCRIPTION OF THE INVENTION

This invention relates to a compact autothermal reformer assemblage which is operable to reform relatively light hydrocarbon fuels such as gasoline, methanol, ethanol, diesel fuel or the like. In the reformer assemblage of this invention, fuel and steam are premixed in a vaporizer section prior to entering the auto-thermal reformer section of the assemblage. The reformer section includes a fuel, steam and air mixing station and the reforming catalyst bed. The catalyst bed can be a two stage bed, the first stage being, for example, an iron oxide catalyst stage and the second stage being, for example, a nickel catalyst stage. The second stage could contain other catalysts, such as noble metal catalysts, for example, rhodium, platinum, palladium, or a mixture of these catalysts. Alternatively, the catalyst bed could be a single stage bed with a noble metal catalyst, preferably rhodium, or a mixed rhodium/platinum catalyst. The vaporized fuel and steam mixture is fed into the mixing station, and air (the oxidizer) is introduced into the mixing station. To minimize reformer section length, the fuel-steam-air mixture must mix rapidly and thoroughly. Minimizing reformer section length reduces the size of the assemblage, which is an important consideration for automobile applications. Minimizing the reformer section also reduces the residence time of the fuel, steam and air mixture in the mixer, thereby minimizing the risk of auto-ignition and of carbon formation prior to the mixture's entering the catalyst bed. In addition, the available pressure drop for mixing is typically small for many applications. Finally, to minimize manufacturing costs, simple mixing designs are desired. The combined mixing and catalyst bed sections of this invention achieves all of the aforesaid goals.

The autothermal reformer assemblage of this invention is preferably cylindrical in shape and, as noted above, is associated with a fuel-steam vaporizer. A mixture of a light hydrocarbon fuel, such as gasoline, and steam, is vaporized in the vaporizer and is then fed into one or more mixing tubes which form a part of the mixer station. The mixing tubes pass through a manifold which receives an oxidant, such as air. The fuel-steam mixture passes axially through the mixing tube(s), and the air enters the tube(s) from the air manifold through radial openings in the tube(s). The pressure differential between the air manifold and the interior of the mixing tube(s) is relatively small whereby the degree of penetration of the air streams in the mixing tubes can be accurately controlled, so that thorough mixing of the air and fuel-steam components can be quickly achieved. The air inlet ports in the mixing tube(s) are axially radial to the axis of the tube so that the air streams enter the mixing tube(s) along paths that are perpendicular to the direction of flow of the fuel-steam mixture in the mixing tube(s). The assemblage and operating conditions of this invention ensures that the air streams will perpendicularly penetrate the fuel-steam mixture stream for a distance that is less than the radius of the mixing tube(s), and generally only about one-half of the radius of the mixing tube(s), and then will be entrained into the fuel-steam stream, moving therewith in the axial direction of the mixing tube(s), thereafter to mix and blend into the fuel-steam stream, thus resulting in an essentially homogeneous fuel-steam-air mixture by the time that the mixture exits from the mixing tubes and enters into the catalyst bed. The assemblage of this invention is operated under conditions wherein the mass flow rate of the fuel-steam mixture through the mixing tubes is approximately equal to the cross flow rate of the air into the mixing tubes, and the Δp between the mixture flowing through the mixing tube and the air in the surrounding manifold is only a few percent of the total operating pressure.

Where the system is changed such that the fuel is vaporized by itself, without the addition of steam, or with just a small amount of steam added, and the steam and air are preheated together in the same heat exchanger, the same system design could be used as shown in the drawings.

The steam-air approach would involve the injection of the vaporized fuel into the steam-air mixture, or vice versa, such that a small number of large holes are used with the low pressure drop, and the degree of penetration is about one quarter of the inside diameter of the mixing tubes. Therefore, any combination of fluids which can provide this degree of penetration would result in optimum mixing with a low pressure drop.

We have ascertained that when the above-identified operating conditions and certain system parameters are met, the desired extent of air penetration into the fuel-steam stream and the degree of mixing of the air, steam and fuel in a sufficiently compact mixing station needed to minimize the likelihood of auto ignition and carbon deposition can be achieved. We have also ascertained that there exists a relationship between the diameter of the mixing tube(s) and the axial distance within the mixing tube(s) which is needed to accomplish a sufficiently thorough mixing of the fuel-steam and air components to meet the aforesaid objectives.

### BRIEF DESCRIPTION OF THE DRAWINGS

FIG. 1 is a somewhat schematic fragmented cross sectional view of one embodiment of a mixing chamber formed in accordance with this invention; and

FIG. 2 is a schematic cross sectional view of one of the mixing tubes showing what occurs inside of the mixing tube during the mixing operation.

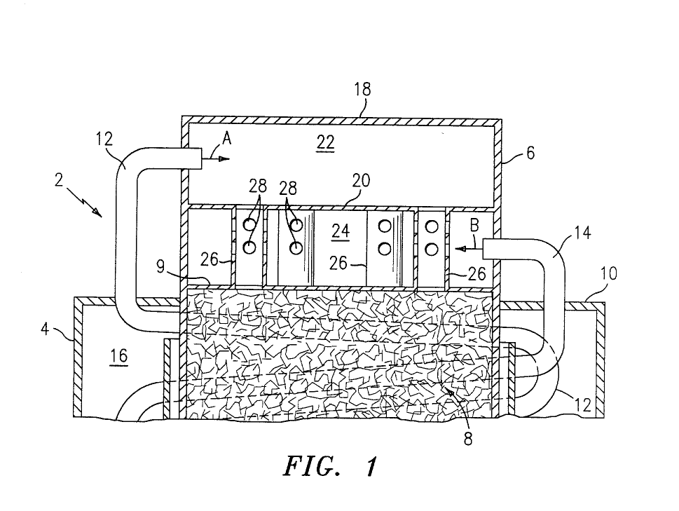

Referring now to the drawings, there is shown in FIG. 1 one proposed embodiment of a mixing chamber which is suitable for providing a fuel-steam-air mixture for use in an autothermal reformer assemblage. The reformer assemblage 2 is generally cylindrical, and includes an outer cylindrical shell 4 and an inner cylindrical shell 6. A reforming catalyst bed 8 is disposed in the inner shell 6 below a first transverse wall 9. The upper end of the outer shell 4 is closed by an annular wall 10. Helical reactant feed tubes 12 and 14 are disposed inside of an annular heat exchange chamber 16 formed by the walls 4, 6 and 10. The tube 12 carries a fuel-steam reactant, and the tube 14 carries an oxidant reactant, usually air. If so desired, the contents of the tubes 12 and 14 could be reversed. A top wall 18 closes the upper end of the inner cylindrical shell 6, and an intermediate wall 20 divides the upper end of the shell 6 into an upper manifold 22 and a lower manifold 24. The lower manifold 24 is separated from the catalyst bed 8 by a wall 9. The tube 12 opens into the upper manifold 22 and the tube 14 opens into the lower manifold 24. Thus the vaporized fuel-steam mixture is fed into the upper manifold 22, and the air stream is fed into the lower manifold 24. A plurality of mixing tubes 26 extend between the upper manifold 22 to the catalyst bed 8 through the wall 9. The mixing tubes 26 interconnect the fuel-steam manifold 22 with the catalyst bed 8. The mixing tubes 26 include radial openings 28 which open into the air manifold 24.

The assemblage 2 operates generally as follows. The vaporized fuel-steam mixture enters the manifold 22 per arrow A and flows out of the manifold 22 to the catalyst bed 8 through the mixing tubes 26. Air enters the manifold 24 per arrow B and enters the mixing tubes 26 through the openings 28. The mixing of the fuel-steam and air occurs in the mixing tubes 26 downstream of the openings 28 as described in detail hereinafter.

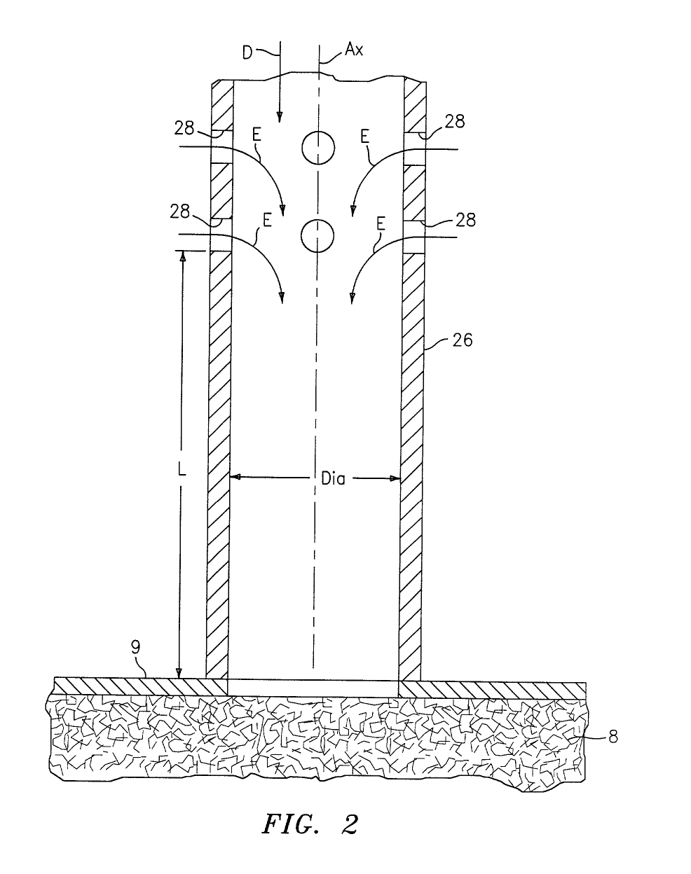

Referring now to FIG. 2, details of the mixing tubes 26 and their mode of operation are illustrated. The axis of the tube bore is denoted by Ax. It will be noted that the axes of the openings 28 are perpendicular to the tube bore axis Ax. The fuel-steam mixture flows through the tubes 26 in the direction of the arrow D and the air flows into the tubes along the paths generally defined by the arrows E. It will be noted that the interaction of the two streams causes the injected stream to turn 90° into the downstream axial direction even at low penetration. The injected jets penetrate the tube bore a distance which is equal to about ¼ of the diameter of the tube bore. We have ascertained that the air will mix thoroughly with the fuel-steam if the openings are offset from the catalyst bed 8 a distance L which is at least about twice the diameter Dia of the tube bore, and may be more than twice the tube bore diameter. The amount of the fuel-steam-air being processed is dependent on the size and/or number of the mixing tube(s), so that the use of several smaller mixing tubes rather than a single large mixing tube will enable the total distance between the walls 20 and 9 of FIG. 1 to be minimized, thereby decreasing the size of the assemblage 2. The limiting factor is the requirement that the air and fuel-steam mixture must reside in the tubes until a thorough mixture is obtained, and the necessary distance traveled by the air and fuel-steam in the tubes is a function of the diameter of the tubes. Thus the smaller the diameter of the tubes, the shorter the needed mixing distance is provided that the tube orifice diameters are selected to maintain optimum penetration of the injection flow conditions as was done in the embodiment of the invention described above.

The following examples describe mixing systems which have been found to achieve a greater than 90% fuel/steam/air mix in a sufficiently short period of time to minimize carbon formation in the mixer.

### EXAMPLE 1

A mixer assembly having ten transfer tubes with five orifices in each tube is able to achieve a 94% mixing efficiency when the tube diameters is 0.75 inch and the orifice diameters is 0.22 inch. The pressure drop between the entrance to the mixer tubes and the inlet end of the catalyst bed is kept at 0.337 inches water, and the pressure drop between the manifold and the interior of the transfer tubes is kept at 0.463 inches water.

### EXAMPLE 2

A mixer assembly having five transfer tubes with four orifices in each tube is able to achieve a 97% mixing efficiency when the tube diameters is 1.00 inch and the orifice diameters is 0.335 inch. The pressure drop between the entrance to the mixer tubes and the inlet end of the catalyst bed is kept at 0.422 inches water, and the pressure drop between the manifold and the interior of the transfer tubes is kept at 0.571 inches water.

### EXAMPLE 3

A mixer assembly having twenty transfer tubes with four orifices in each tube is able to achieve a 98% mixing efficiency when the tube diameters is 0.55 inch and the orifice diameters is 0.185 inch. The pressure drop between the entrance to the mixer tubes and the inlet end of the catalyst bed is kept at 0.334 inches water, and the pressure drop between the manifold and the interior of the transfer tubes is kept at 0.418 inches water.

### EXAMPLE 4

A mixer assembly having twenty transfer tubes with four orifices in each tube is able to achieve a 97% mixing efficiency when the tube diameters is 0.364 inch and the orifice diameters is 0.104 inch. The pressure drop between the entrance to the mixer tubes and the inlet end of the catalyst bed is kept at 1.75 inches water, and the pressure drop between the manifold and the interior of the transfer tubes is kept at 3.74 inches water.

### EXAMPLE 5

A mixer assembly having twenty transfer tubes with four orifices in each tube is able to achieve a 97% mixing efficiency when the tube diameters is 0.364 inch and the orifice diameters is 0.104 inch. The pressure drop between the entrance to the mixer tubes and the inlet end of the catalyst bed is kept at 0.37 inches water, and the pressure drop between the manifold and the interior of the transfer tubes is kept at 0.76 inches water.

### EXAMPLE 6

A mixer assembly having twelve transfer tubes with five orifices in each tube is able to achieve a 96% mixing efficiency when the tube diameters is 0.622 inch and the orifice diameters is 0.1405 inch. The pressure drop between the entrance to the mixer tubes and the inlet end of the catalyst bed is kept at 0.61 inches water, and the pressure drop between the manifold and the interior of the transfer tubes is kept at 1.84 inches water.

### EXAMPLE 7

A mixer assembly having ten transfer tubes with four orifices in each tube is able to achieve a 97% mixing efficiency when the tube diameters is 0.493 inch and the orifice diameters is 0.1406 inch. The pressure drop between the entrance to the mixer tubes and the inlet end of the catalyst bed is kept at 2.05 inches water, and the pressure drop between the manifold and the interior of the transfer tubes is kept at 4.30 inches water.

### EXAMPLE 8

A mixer assembly having fifteen transfer tubes with five orifices in each tube is able to achieve a 96% mixing efficiency when the tube diameters is 0.493 inch and the orifice diameters is 0.116 inch. The pressure drop between the entrance to the mixer tubes and the inlet end of the catalyst bed is kept at 0.99 inches water, and the pressure drop between the manifold and the interior of the transfer tubes is kept at 2.58 inches water.

It will be appreciated that all of the aforesaid specific mixer configurations achieved better than a 90% mixing efficiency, and that, generally speaking, the greater the number of transfer tubes, the more efficient the mixing is.

It will be appreciated that the reformer assemblage and air-fuel-steam mixer component can be made sufficiently compact so as to be useful in a vehicular applications. The reformer is preferably an autothermal reformer so as to be operable with liquid fuels such as gasoline or diesel fuel. The catalyst bed is thus preferably a two stage bed, with the initial stage having an iron oxide or equivalent catalyst, and the second stage having a nickel or equivalent catalyst. The catalyst bed could, however, instead be a single stage bed, with a noble metal rhodium or a rhodium-platinum catalyst being preferred. The fact that there is a unique relationship between the number and size of the air-admitting holes for perpendicular injection of the air into the mixing tubes provides a fast and thorough mixing of the fuel-steam and air constituents thereby ensuring a homogeneous mixture of air, steam and fuel at the entrance of the catalyst bed at a minimum pressure drop.

Since many changes and variations of the disclosed embodiment of the invention may be made without departing from the inventive concept, it is not intended to limit the invention otherwise than as required by the appended claims.

What is claimed is:

1. A hydrocarbon fuel autothermal reformer assembly comprising:
a) a catalyst bed, said catalyst bed including an inlet end;
b) an air/fuel/steam mixing station adjacent to said inlet end of said catalyst bed, said mixing station including an inlet chamber, a manifold interposed between said inlet chamber and said catalyst bed inlet end, and a plurality of cylindrical transfer tubes extending through said manifold from said inlet chamber to said inlet end of said catalyst bed;
c) a plurality of gas entry passages in side walls of each of said transfer tubes, each of said gas passages having an axis which is perpendicular to an axis of said transfer tubes, each of said gas entry passages being spaced apart from said catalyst bed inlet end a distance which is at least two times the diameter of said cylindrical transfer tubes;
d) a first gas inlet passage opening into said inlet chamber; and
e) a second gas inlet passage opening into said manifold.

2. The autothermal reformer assembly of claim 1 further comprising a vaporizer station connected with one of said first or second gas inlet passages, said vaporizer being operable to vaporize a fuel/steam mixture prior to entry of the mixture into said mixing station.

3. A method for mixing a fuel/steam gas with an oxidant gas to form an essentially homogeneous fuel/steam/oxidant mixture suitable for use in an autothermal fuel gas reformer catalyst bed, said method comprising the steps of:
a) providing an autothermal reformer catalyst bed having an inlet end;
b) providing an air/fuel/steam mixing station adjacent to said inlet end of said catalyst bed, said mixing station including an inlet chamber, a manifold interposed between said inlet chamber and said catalyst bed inlet end;
c) providing a plurality of cylindrical transfer tubes extending through said manifold from said inlet chamber to said inlet end of said catalyst bed each of said cylindrical transfer tubes having a plurality of gas entry passages in side walls of each of said transfer tubes, each of said gas passages having an axis which is perpendicular to an axis of said transfer tubes, each of said gas entry passages being spaced apart from said catalyst bed inlet end a distance which is at least two times the diameter of said cylindrical transfer tubes;
d) providing a first gas inlet passage opening into said inlet chamber;
e) providing a second gas inlet passage opening into said manifold;
f) Introducing a vaporized fuel/steam mixture into one of said inlet chamber or said manifold;
g) introducing an oxidant gas into the other of said inlet chamber or said manifold;
h) causing one of said fuel/steam mixture or said oxidant gas stream to flow axially through said transfer tubes toward said inlet end of said catalyst bed;
i) causing the other of said fuel/steam mixture or said oxidant to flow from said manifold radially into said transfer tubes through said gas entry passages; and
j) maintaining a pressure differential between the interior of said transfer tubes and said manifold which will result in the radially flowing stream entering said transfer tubes to be entrained and deflected into the axially flowing stream in the transfer tubes before the radially flowing stream penetrates the interior of the transfer tubes a distance which is about one-half of the radius of the interior of the transfer tubes.

4. The method of claim 3 wherein said pressure differential between the gas stream in said transfer tubes and the gas stream in said manifold is only a few percentage points.

5. The method of claim 3 wherein the fuel is gasoline.

6. The method of claim 3 wherein the fuel is diesel fuel.

7. The method of claim 3 wherein the fuel is methanol.

8. A method for mixing a fuel/steam gas with an oxidant gas to form an essentially homogeneous fuel/steam/oxidant mixture suitable for use in an autothermal fuel gas reformer catalyst bed, said mixing method taking place in a fuel processing apparatus which includes an autothermal reformer catalyst bed having an inlet end, an oxidant/fuel/steam mixing station adjacent to said inlet end of said catalyst bed, said mixing station including an inlet chamber, a manifold interposed between said inlet chamber and said catalyst bed inlet end, and a plurality of cylindrical transfer tubes extending through said manifold from said inlet chamber to said inlet end of said catalyst bed each of said cylindrical transfer tubes having a plurality of gas entry passages in side walls of each of said transfer tubes, each of said gas passages having an axis which is perpendicular to an axis of said transfer tubes, each of said gas entry passages being spaced apart from said catalyst bed inlet end a distance which is at least two times the diameter of said cylindrical transfer tubes, said method comprising the steps of:
a) providing a first gas inlet passage opening into said inlet chamber;
b) providing a second gas inlet passage opening into said manifold;
c) Introducing a vaporized fuel/steam mixture into one of said inlet chamber or said manifold;
d) introducing an oxidant gas into the other of said inlet chamber or said manifold;
e) causing one of said fuel/steam mixture or said oxidant gas stream to flow axially through said transfer tubes toward said inlet end of said catalyst bed;
f) causing the other of said fuel/steam mixture or said oxidant to flow from said manifold radially into said transfer tubes through said gas entry passages; and
g) maintaining a pressure differential between the interior of said transfer tubes and said manifold which will result in the radially flowing stream entering said transfer tubes to be entrained and deflected into the axially flowing stream in the transfer tubes when the radially flowing stream penetrates the interior of the transfer tubes a distance which is about one-half the radius of the interior of the transfer tubes.

9. The method of claim 8 wherein the fuel is gasoline.

10. The method of claim 8 wherein the fuel is diesel fuel.

11. The method of claim 8 wherein the fuel is methanol.

12. The method of claim 8 wherein said fuel/steam mixture is passed axially through said transfer tubes and said oxidant enters said transfer tubes from said manifold.

13. A method for mixing an oxidant/steam gas with a vaporized fuel to form an essentially homogeneous fuel/steam/oxidant mixture suitable for use in an autothermal fuel gas reformer catalyst bed, said mixing method taking place in a fuel processing apparatus which includes an autothermal reformer catalyst bed having an inlet end, an oxidant/fuel/steam mixing station adjacent to said inlet end of said catalyst bed, said mixing station including an inlet chamber, a manifold interposed between said inlet chamber and said catalyst bed inlet end, and a plurality of cylindrical transfer tubes extending through said manifold from said inlet chamber to said inlet end of said catalyst bed each of said cylindrical transfer tubes having a plurality of gas entry passages in side walls of each of said transfer tubes, each of said gas passages having an axis which is perpendicular to an axis of said transfer tubes, each of said gas entry passages being spaced apart from said catalyst bed inlet end a distance which is at least two times the diameter of said cylindrical transfer tubes, said method comprising the steps of:
a) providing a first gas inlet passage opening into said inlet chamber;
b) providing a second gas inlet passage opening into said manifold;
c) Introducing a vaporized fuel stream into one of said inlet chamber or said manifold;
d) introducing an oxidant/steam mixture into the other of said inlet chamber or said manifold;
e) causing one of said fuel stream or said oxidant/steam mixture to flow axially through said transfer tubes toward said inlet end of said catalyst bed;
f) causing the other of said vaporized fuel stream or said oxidant/steam mixture to flow from said manifold radially into said transfer tubes through said gas entry passages; and
g) maintaining a pressure differential between the interior of said transfer tubes and said manifold which will result in the radially flowing stream entering said transfer tubes to be entrained and deflected into the axially flowing stream in the transfer tubes when the radially flowing stream penetrates the interior of the transfer tubes a distance which is about one-half the radius of the interior of the transfer tubes.

14. The method of claim 13 wherein the fuel is gasoline.

15. The method of claim 13 wherein the fuel is diesel fuel.

16. The method of claim 13 wherein the fuel is methanol.

17. The method of claim 13 wherein said fuel stream is passed axially through said transfer tubes and said oxidant/steam mixture enters said transfer tubes from said manifold.
